(19) United States
(12) Patent Application Publication
(10) Pub. No.: US 2020/0191066 A1
(43) Pub. Date: Jun. 18, 2020

(54) INTAKE DEVICE FOR INTERNAL COMBUSTION ENGINE

(71) Applicant: AISIN SEIKI KABUSHIKI KAISHA, Kariya-shi, Aichi-ken (JP)

(72) Inventors: Keisuke SEKIGUCHI, Kariya-shi, Aichi-ken (JP); Hiromitsu ISHIHARA, Okazaki-shi, Aichi-ken (JP); Tomohiro YAMAGUCHI, Toyota-shi, Aichi-ken (JP)

(73) Assignee: AISIN SEIKI KABUSHIKI KAISHA, Kariya-shi, Aichi-ken (JP)

(21) Appl. No.: 16/323,286

(22) PCT Filed: Mar. 27, 2017
(86) PCT No.: PCT/JP2017/012228

§ 371 Date: Feb. 5, 2019

(30) Foreign Application Priority Data
Aug. 9, 2016 (JP) 2016-156522

(51) Int. Cl. F02D 9/10; F02M 35/104

(52) U.S. Cl. CPC F02D 9/10; F02M 35/104

(57) ABSTRACT

An intake device for an internal combustion engine includes a valve body and a holding member. The valve body includes a pivot shaft and a valve portion configured to change a passage cross-sectional area of an intake passage. The holding member includes a support portion that pivotally supports the pivot shaft and accommodates the valve body. The holding member is arranged in an inner wall surface of the intake passage. The valve body includes a side wall located between the pivot shaft and the valve portion. The side wall closes a gap between the pivot shaft and the support portion around an entire circumference of the pivot shaft from the intake passage in an axial direction of the pivotal shaft.

### TECHNICAL FIELD

The present invention relates to an intake device for an internal combustion engine and, more particularly, to an intake device for an internal combustion engine including a valve body that controls the flow of a gas supplied to a combustion chamber of the internal combustion engine.

### BACKGROUND ART

Patent Document 1 discloses an example of a known intake device for an internal combustion engine. The intake device of the internal combustion engine includes an intake passage through which a gas flows, a valve body arranged inside the intake passage and configured to change the cross-sectional area of the intake passage, and a control valve housing that pivotally supports a pivot shaft of the valve body at a support portion (bearing).

### PRIOR ART DOCUMENT

### Patent Document

Patent Document 1: Japanese Laid-Open Patent Publication No. 2015-1196

### SUMMARY OF THE INVENTION

### Problems that are to be Solved by the Invention

With such an intake device for an internal combustion engine, however, a part of a gap between the pivot shaft and the support portion is exposed to the intake device. Thus, when a gas flows in the intake passage, the gas may flow into the gap. This may cause a pressure loss that reduces the intake efficiency.

It is an object of the present invention to provide an intake device for an internal combustion engine that limits reduction of the intake efficiency.

### Means for Solving the Problem

In order to achieve the above object, an intake device for an internal combustion engine includes a valve body and a holding member. The valve body includes a pivot shaft and a valve portion configured to change a passage cross-sectional area of an intake passage. The holding member includes a support portion that pivotally supports the pivot shaft and accommodates the valve body. The holding member is arranged in an inner wall surface of the intake passage. The valve body includes a side wall located between the pivot shaft and the valve portion. The side wall closes a gap between the pivot shaft and the support portion around an entire circumference of the pivot shaft from the intake passage in an axial direction of the pivotal shaft.

### BRIEF DESCRIPTION OF THE DRAWINGS

FIG. 1 is a perspective view showing the structure of one embodiment of an intake device for an internal combustion engine.

FIG. 2A is a side view showing a valve body of the intake device for an internal combustion engine in the embodiment.

FIG. 2B is a cross-sectional view taken along line 2B-2B in FIG. 2A.

FIG. 2C is a plan view showing the valve body.

FIG. 3A is a cross-sectional view showing the structure of one embodiment of an intake device for an internal combustion engine.

FIG. 3B is a cross-sectional view taken along line 3B-3B in FIG. 3A.

FIG. 4A is a cross-sectional view showing the structure of one embodiment of an intake device for an internal combustion engine.

FIG. 4B is a cross-sectional view taken along line 4B-4B in FIG. 4A.

FIG. 5A is a cross-sectional view showing the intake device for an internal combustion engine that corresponds to FIG. 3A in an open state in the embodiment.

FIG. 5B is a cross-sectional view showing the intake device for an internal combustion engine that corresponds to FIG. 3A in the open state in a comparative example.

FIG. 6A is a cross-sectional view taken along line 6A-6A in FIG. 5A.

FIG. 6B is a cross-sectional view taken along line 6B-6B in FIG. 5B.

FIG. 7A is a cross-sectional view showing the intake device for an internal combustion engine that corresponds to FIG. 4A in a restriction state in the embodiment.

FIG. 7B is a cross-sectional view showing the intake device for an internal combustion engine that corresponds to FIG. 4A in the restriction state in a comparative example.

FIG. 8A is a cross-sectional view taken along line 8A-8A in FIG. 7A.

FIG. 8B is a cross-sectional view taken along line 8B-8B in FIG. 7B.

### EMBODIMENTS OF THE INVENTION

One embodiment of an intake device for an internal combustion engine will now be described.

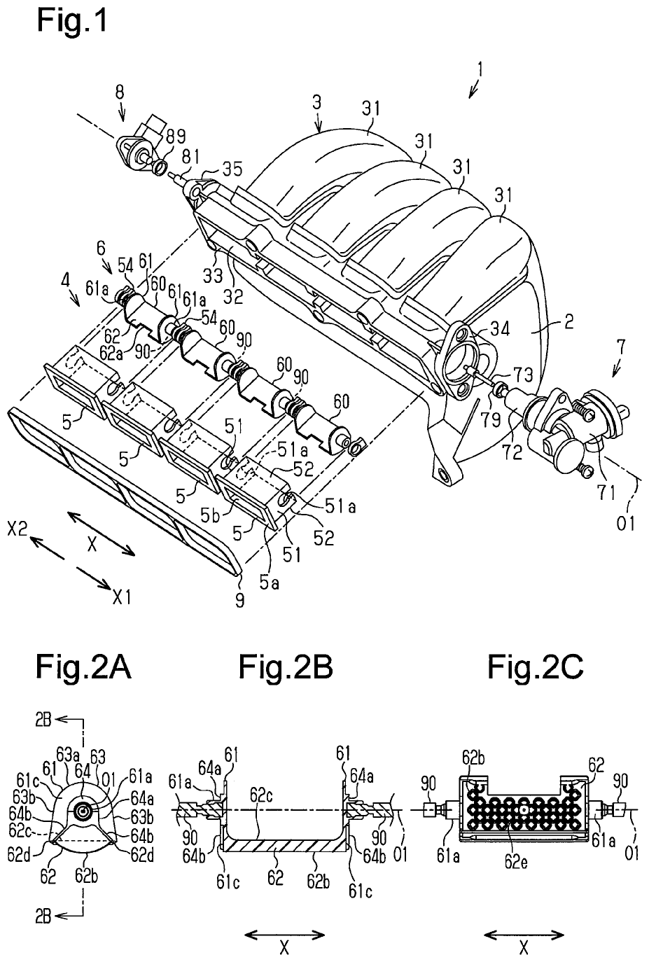

As shown in FIG. 1, an intake device 1 installed in an inline four-cylinder engine for a vehicle draws in air, mixes the air with fuel supplied from an injector, and supplies the mixed air (hereafter referred to as “air-fuel mixture”) to a combustion chamber when an intake valve opens in an intake stroke of the engine. The engine compresses and ignites the air-fuel mixture in the combustion chamber to burn the air-fuel mixture. The engine transmits expansion force resulting from the combustion from a piston to a crankshaft. This obtains the driving force of the engine from the crankshaft.

The intake device 1 includes a surge tank 2 and a resin intake manifold 3 that forms a plurality of (four) intake passages 31 branching from an outlet side of the surge tank 2. The direction in which the intake passages 31 are arranged next to one another is referred to as the X direction. One side and the other side (right side and left side in FIG. 1) in the X direction are respectively referred to as the X1 side and the X2 side.

Outlets of the intake passages 31 are entirely connected to form a substantially tubular inner wall surface 32 and also form an open end 33 that extends around the entire edge of an opening of the inner wall surface 32. The open end 33 is for connection to a cylinder head (not shown). The open end 33 includes a groove (not shown) into which a gasket 9 is fitted.

The intake device 1 also includes an intake control valve 4 in the vicinity of the outlet of the intake manifold 3.

The intake control valve 4 includes a plurality of (four) holding members 5 fitted into the inner wall surface 32 in correspondence with the intake passages 31. The holding members 5 are each substantially box-shaped and include two holding side walls 51 opposing each other in the X direction and two walls 52 connecting distal ends of the holding side walls 51 in the X direction, thereby forming an opening 5b that has a predetermined open area (cross-sectional area of flow passage). One of the ends of the holding member 5 includes a substantially rectangular flange 5a extending outward. The two holding side walls 51 each include a substantially U-shaped support groove 51a open toward the intake passage 31 and in communication in the X direction.

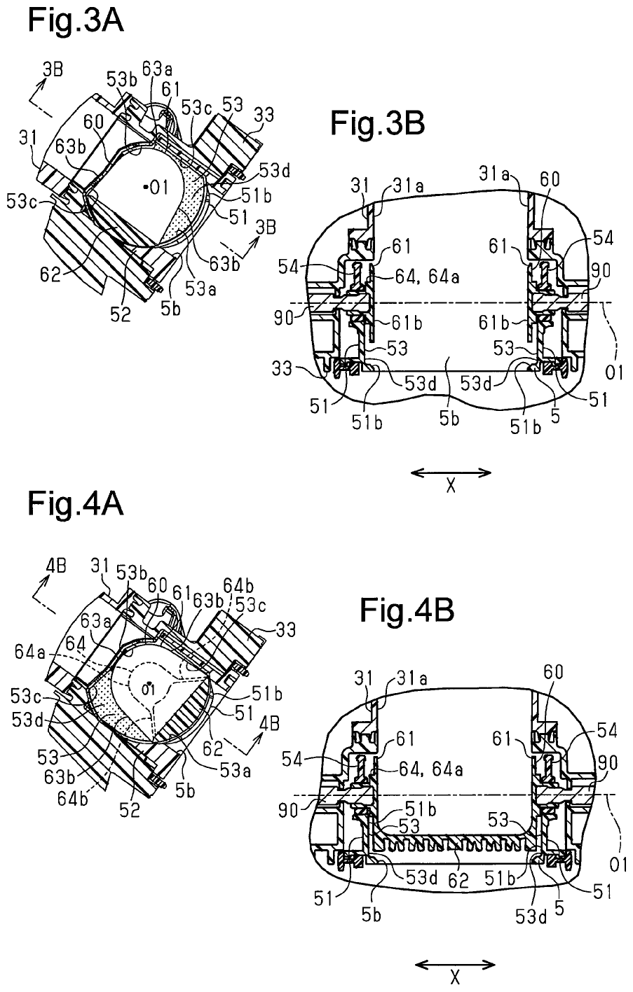

As shown in FIGS. 3A and 3B, the holding side walls 51 include inner surfaces 51b opposing each other in the X direction, and the inner surfaces 51b are arranged to be substantially flush with inner surfaces 31a of the intake passage 31, which oppose each other in the X direction, in an opening direction of the opening 5b (intake passage 31). The holding member 5 includes two accommodation recesses 53, which are substantially sectoral grooves recessed away from each other in the X direction from the inner surfaces 51b of the holding side walls 51. Each of the accommodation recesses 53 is defined by a large diameter arcuate portion 53a, a small diameter arcuate portion 53b, and two straight portions 53c connecting the ends of the arcuate portions. As viewed in the X direction, the large diameter arcuate portion 53a is arcuate and extends about an axis (hereafter “axis O1”) that extends in the X direction. The small diameter arcuate portion 53b is arcuate and extends about the axis O1 and has a smaller diameter and a shorter length than the large diameter arcuate portion 53a. The straight portions 53c are each substantially straight and extend between an end of the large diameter arcuate portion 53a and a corresponding end of the small diameter arcuate portion 53b.

As shown in FIG. 1, the intake control valve 4 includes an intake control valve body 6. The intake control valve body 6 includes a plurality of (four) valve bodies 60 arranged next to one another in the X direction.

Each valve body 60 is formed by integrating two flat side walls 61 and a semi-cylindrical valve portion 62. The side walls 61 face the holding side walls 51 of the holding member 5. The valve portion 62 connects distal ends of the side walls 61 in the X direction. The side walls 61 are connected to the valve portion 62 in a state orthogonal to the valve portion 62. A part of the valve portion 62 is cut away to form a control passage portion 62a.

The side walls 61 of the valve body 60 each include a substantially boss-like shaft 61a. The shafts 61a project away from each other in the X direction. The shaft 61a is inserted through a substantially keyhole-shaped bearing member 54 (support portion), which opens in the X direction. The bearing member 54 is fitted into the support groove 51a of the holding member 5. That is, the holding member 5 pivotally supports the shaft 61a at the bearing member 54. Thus, the valve body 60 is pivotally supported by the holding member 5 (bearing member 54) about the axis O1.

As shown in FIGS. 2A to 2C, the valve portion 62 includes an outer surface 62b, which is substantially arcuate and extends about the axis O1, and an inner surface 62c, which extends straight to connect the two ends of the outer surface 62b. The side wall 61 is substantially tongue-shaped and includes a periphery 63 with an arcuate peripheral portion 63a at a side of the axis O1 opposite to the valve portion 62 (in a range extending about the axis O1 in the circumferential direction excluding the range including the valve portion 621). The arcuate peripheral portion 63a has a diameter (large diameter) larger than the shaft 61a and a diameter (small diameter) smaller than the maximum distance to the valve portion 62. Further, the periphery 63 of the side wall 61 includes straight peripheral portions 63b on connecting two ends 62d of the valve portion 62 to tangential lines of the arcuate peripheral portion 63a. The diameters of the valve portion 62 and the arcuate peripheral portion 63a are substantially the same as the diameter of the large diameter arcuate portion 53a and the diameter of the small diameter arcuate portion 53b. Further, the straight peripheral portion 63b has substantially the same length as the straight portion 53c.

A projection 64 serving as a valve projection projects from a side surface 61c of the side wall 61. The side surface 61c serves as a first opposing surface that is the side where the shaft 61a is located. The projection 64 includes a projection central portion 64a shaped to be substantially circular around the shaft 61a and two projection ribs 64b extending from the projection central portion 64a to connect the center of the shaft 61a to the ends 62d of the valve portion 62. The outer surface 62b of the valve portion 62 includes a meshed rib 62e.

As shown in FIG. 1, the intake control valve body 6 includes a plurality of (three) metal connection shafts (pivot shaft) 90 that connect adjacent valve bodies 60 in the X direction. That is, the two ends of the connection shaft 90 are each fixed to the shafts 61a of the adjacent one of the valve bodies 60. Thus, the valve bodies 60 are all pivoted integrally about the axis O1 extending in the X direction.

As shown in FIGS. 3A and 3B, the distance between the side walls 61 in the X direction is set to be substantially the same as the width of the opening 5b in the X direction. In other words, inner surfaces 61b of the side walls 61 opposing each other in the X direction are arranged to be substantially flush with the inner surfaces 51b of the holding side walls 51 (and the inner surfaces 31a of the intake passage 31) in an opening direction of the holding member 5 (intake passage 31). Further, the projection 64 is proximate and opposed to a bottom surface 53d of the accommodation recess 53 serving as a second opposing surface in the X direction.

As shown in FIGS. 3A and 3B, when the valve portion 62 is in a pivot position in which the valve portion 62 lies along the wall 52 to open the opening 5b, the valve body 60 is in an open state that maximizes an open area of the opening 5b. Specifically, in the open state, the straight peripheral portion 63b at a leading side (left side in FIG. 3A) when pivoted clockwise about the axis O1 approaches the corresponding straight portion 53c of the accommodation recess 53. In contrast, as shown in FIGS. 4A and 4B, when the valve portion 62 is in a pivot position in which the valve portion 62 rises from the wall 52 to close a part of the opening 5b, the valve body 60 is in a restriction state that minimizes the open area of the opening 5b. Specifically, in the restriction state, the straight peripheral portion 63b at a leading side (right side in FIG. 4A) when pivoted counterclockwise about the axis O1 approaches the corresponding straight portion 53c of the accommodation recess 53. Further, in the restriction state, the projection ribs 64b are arranged to define the side of the intake passage 31 and an outlet side of the intake passage 31 in the opening direction of the holding member 5 (intake passage 31). In other words, the holding member 5 accommodates the valve body 60 (side wall 61 and a side wall of valve portion 62) to allow the valve body 60 to pivot in the accommodation recess 53 in a range from the open state (FIGS. 3A and 3B) to the restriction state (FIGS. 4A and 4B).

As shown in FIG. 1, a first attachment portion 34 is formed near the outlet of the intake manifold 3 at the X1 side. An electric actuator 7 is attached to the first attachment portion 34.

The electric actuator 7 includes a motor 71, a drive gear 72, and a metallic pivot shaft 73. The drive gear 72 is driven by and connected to the motor 71 and pivoted about the axis O1. The pivot shaft 73 is substantially cylindrical, concentric with the axis O1, and includes an end directed toward the X1 side and connected to the drive gear 72 to be pivoted integrally with the drive gear 72. An end of the pivot shaft 73 at the X2 side is inserted through the first attachment portion 34 and connected to the adjacent valve body 60, that is, the intake control valve body 6 so as to pivot integrally with the valve body 60. In other words, the pivot shaft 73 and the intake control valve body 6 are integrally pivoted when the drive gear 72 pivots about the axis O1.

A mechanical lock unit (not shown) is arranged between the drive gear 72 and the intake manifold 3. The mechanical lock unit restricts the rotation of the drive gear 72 when the phases of the drive gear 72 and the intake manifold 3 reach predetermined initial phases (i.e., phases that correspond to the open state of the valve body 60). The pivot shaft 73 is inserted through an annular sealing member 79 arranged between the pivot shaft 73 and the first attachment portion 34. The sealing member 79 prevents the leakage of gas out of the intake passage 31 from between the first attachment portion 34 and the pivot shaft 73.

A second attachment portion 35 is formed near the outlet of the intake manifold 3 at the X2 side. A sensor unit 8 is attached to the second attachment portion 35.

The sensor unit 8 includes a metallic pivot shaft 81. The pivot shaft 81 is substantially cylindrical and concentric with the axis O1 in the same manner as the pivot shaft 73. An end of the pivot shaft 81 at the X1 side is inserted through the second attachment portion 35 and connected to the adjacent valve body 60, that is, the intake control valve body 6, so as to pivot integrally with the valve body 60. In other words, the pivot shaft 81 and the intake control valve body 6 are integrally pivoted when the intake control valve body 6 pivots about the axis O1. The sensor unit 8 is configured to detect the pivot position of the pivot shaft 81, that is, opening degree information of the intake control valve body 6. In the same manner as the pivot shaft 73, the pivot shaft 81 is inserted through an annular sealing member 89 arranged between the pivot shaft 81 and the second attachment portion 35.

Thus, in the intake device 1, the two pivot shafts 73 and 81 and the intake control valve body 6 are pivoted integrally about the axis O1. The electric actuator 7 is drive-controlled by an electronic control unit (not shown). The electronic control unit drive-controls the electric actuator 7 to control the position of the intake control valve body 6 based on information obtained from an operation map in accordance with engine speed and a load condition. In this case, the electronic control unit performs feedback control when driving the electric actuator 7 based on the opening degree information of the intake control valve body 6 detected by the sensor unit 8.

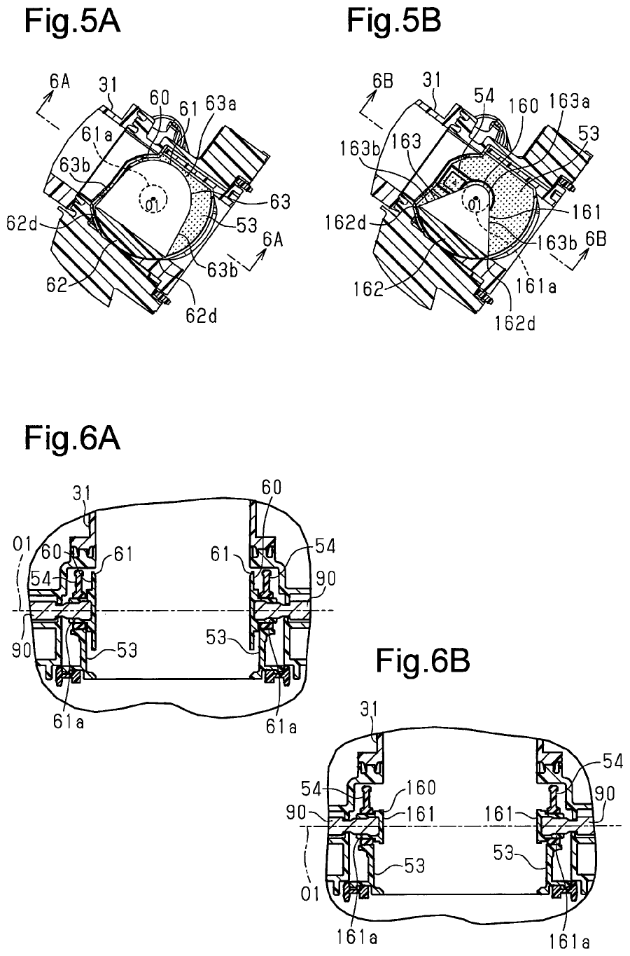

In the present embodiment, the arcuate peripheral portion 63a having a larger diameter than the shaft 61a is formed on the periphery 63 of the side wall 61 of the valve body 60, thereby reducing the range of an exposed portion of the accommodation recess 53. FIGS. 5A to 8B show the valve body 60 in the present embodiment and a valve body 160 in a comparative example corresponding to the valve body 60. The exposed portion of the accommodation recess 53 in the drawings is shaded for the sake of convenience.

As shown in FIG. 5B, the valve body 160 in the comparative example corresponding to the valve body 60 includes a valve portion 162, which is similar to the valve portion 62, and a side wall 161 corresponding to the side wall 61. The side wall 161 is substantially sectoral and includes a periphery 163 with an arcuate peripheral portion 163a at a side of the axis O1 opposite to the valve portion 162 (in a range excluding where the valve portion 162 is located in the circumferential direction extending about the axis O1). The arcuate peripheral portion 163a has substantially the same diameter as a shaft 161a. Further, the periphery 163 of the side wall 161 includes straight peripheral portions 163b connecting ends 162d of the valve portion 162 to tangential lines of the arcuate peripheral portion 163a.

As shown in comparison with FIGS. 5A and 5B, in the open state, the side wall 61 of the present embodiment reduces the range of a portion of the accommodation recess 53 exposed to the intake passage 31 from the side wall 161 of the comparative example.

As shown in FIG. 6A, the side wall 61 of the present embodiment closes the gap between the shaft 61a and the bearing member 54 from the intake passage 31 around the entire circumference of the shaft 61a in the direction of the axis O1. In contrast, as shown in FIG. 6B, the side wall 161 of the comparative example exposes a part of the gap between the shaft 161a and the bearing member 54 to the intake passage 31 in the direction of the axis O1.

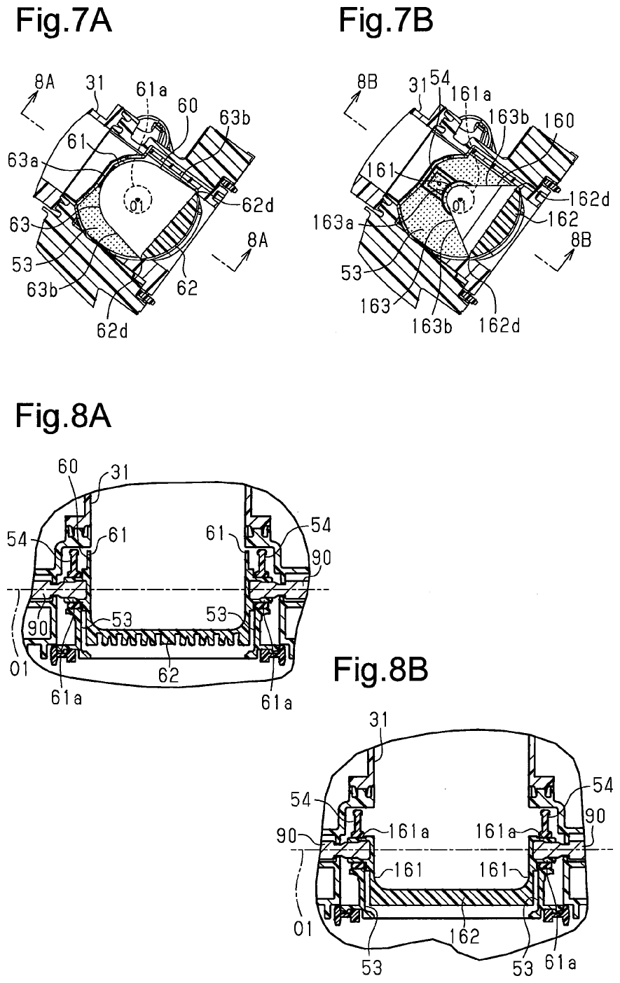

Further, as shown in comparison with FIGS. 7A and 7B, in the restriction state, the side wall 61 of the present embodiment reduces the range of a portion of the accommodation recess 53 exposed to the intake passage 31 from the side wall 161 of the comparative example in the same manner as the open state.

Further, as shown in comparison with FIGS. 8A and 8B, in the restriction state, the side wall 61 of the present embodiment closes the gap around the entire circumference of the shaft 61a. The side wall 161 of the comparative example exposes a part of the gap in the same manner as the open state.

The above embodiment has the following advantages.

(1) In the present embodiment, the side wall 61 closes the gap between the shaft 61a and the inner circumferential surface of the bearing member 54 around the entire circumference of the shaft 61a from the intake passage 31 so that gas flowing inside the intake passage 31 and foreign matter are less likely to enter the gap. This prevents foreign matter from producing sliding resistance relative to the bearing member 54 of the valve body 60 and limits decreases in the intake efficiency.

(2) In the present embodiment, the accommodation recess 53 accommodates the side walls 61 to allow the valve portion 62 to be pivoted in a range from the restriction state (FIG. 4A) to the open state (FIG. 3A). Thus, in the open state of the valve portion 62, a portion of the accommodation recess 53 that allows the valve portion 62 to be pivoted to the restriction state is exposed to the intake passage 31. Further, a pressure loss is produced in the gas flowing through the intake passage 31 by a step in the exposed portion of the accommodation recess 53 between the inner surface 31a of the intake passage 31 and the inner surface 61b of the side wall 61. However, in the open state of the valve portion 62 (i.e., valve body 60), the pressure loss is decreased by reducing the range of the exposed portion of the accommodation recess 53 by an amount corresponding to a portion of the arcuate peripheral portion 63a (portion larger than the diameter of the arcuate peripheral portion 163a of the side wall 161 of the comparative example).

(3) In the present embodiment, the side wall 61 includes the straight peripheral portion 63b on a side directed toward the restriction state (pivotal distal end of the side wall 61 when the valve body 60 is pivoted to the restriction state). Thus, for example, when the accommodation recess 53 includes the straight portion 53c having substantially the same shape as the straight peripheral portion 63b at an opposing location, the straight peripheral portion 63b of the side wall 61 abuts the accommodation recess 53 of the accommodation recess 53 in a substantially planar manner. This minimizes the range of the abutment of the side wall 61 and the accommodation recess 53, thereby minimizing the gap between the side wall 61 and the accommodation recess 53.

(4) In the present embodiment, the projection 64 (valve projection or holding member projection) is small. Thus, gas is less likely to enter the gap with a very simple structure by reducing the gap between the side surface 61c (first opposing surface) of the side wall 61 and the bottom surface 53d (second opposing surface) of the accommodation recess 53 by the reduced portion of the projection 64.

(5) In the present embodiment, when the valve portion (i.e., valve body 60) is in the restriction state, gas is less likely to enter the gap between the side surface 61c (first opposing surface) of the side wall 61 and the bottom surface 53d (second opposing surface) of the accommodation recess 53. In other words, when the valve portion 62 (i.e., valve body 60) is in the restriction state, the gas is allowed to flow near the inner surface 61b of the side wall 61 flush with the inner surface 31a of the intake passage 31 in the X direction, thereby improving the accuracy of the cross-sectional area of the intake passage.

(6) In the present embodiment, the meshed rib 62e is formed on the bottom of the valve portion 62 to improve strength against the pressure of gas flowing inside the intake passage 31, for example.

The embodiment may be modified as described below.

In the embodiment, the straight peripheral portion 63b may be replaced with a curve that connects the arcuate peripheral portion 63a to the end 62d of the valve portion 62. Further, the straight peripheral portion 63b may be omitted by setting substantially the same diameter for the arcuate peripheral portion 63a and the valve portion 62.

In the embodiment, the projection 64 serving as a valve projection located at the side surface 61c serving as a first opposing surface may additionally include or be replaced with the projection 64 serving as a holding member projection located at the inner surface 51b serving as the second opposing surface.

In the embodiment, the projection 64 may be formed along the periphery 63 of the side wall 61.

In the embodiment, the projection rib 64b may be a single straight rib connecting the ends 62d of the valve portion 62.

In the embodiment, the projection central portion 64a may be substantially elliptic or substantially polygonal.

In the embodiment, the bearing member 54 may be configured to support the connection shaft 90. In this case, the side wall 61 preferably closes the gap between the connection shaft 90 and the inner circumferential surface of the bearing member 54 around the entire circumference of the connection shaft 90 from the intake passage 31.

In the embodiment, the projection ribs 64b may be arranged in accordance with the open state of the valve body 60.

1. An intake device for an internal combustion engine, the intake device comprising:
a valve body including a pivot shaft and a valve portion configured to change a passage cross-sectional area of an intake passage; and
a holding member including a support portion that pivotally supports the pivot shaft and accommodating the valve body, wherein
the holding member is arranged in an inner wall surface of the intake passage,
the valve body includes a side wall located between the pivot shaft and the valve portion, and
the side wall closes a gap between the pivot shaft and the support portion around an entire circumference of the pivot shaft from the intake passage in an axial direction of the pivotal shaft.

2. The intake device for an internal combustion engine according to claim 1, wherein
the holding member includes an accommodation recess, the accommodation recess accommodating the side wall to allow the valve portion to be pivoted in a range from a restriction state that minimizes the passage cross-sectional area to an open state that maximizes the passage cross-sectional area,
the side wall includes an arcuate peripheral portion, the arcuate peripheral portion being located in a range of the side wall excluding a range where the valve portion is arranged in a circumferential direction of an axis of the pivot shaft, and
the arcuate peripheral portion extends about the axis of the pivot shaft and has a diameter larger than the pivot shaft and smaller than a maximum distance to the valve portion.

3. The intake device for an internal combustion engine according to claim 2, wherein
the side wall includes a straight peripheral portion that connects an end of the valve portion to a tangential line of a leading portion of the arcuate peripheral portion in a pivotal direction in which the valve body is directed when moved toward the restriction state.

4. The intake device for an internal combustion engine according to claim 2, wherein
the side wall includes a first opposing surface opposing the accommodation recess that accommodates the side wall,
the accommodation recess includes a second opposing surface opposing the accommodated side wall, and
the intake device includes a projection that is at least one of a valve projection projecting from the first opposing surface toward the second opposing surface or a holding member projection projecting from the second opposing surface toward the first opposing surface.

5. The intake device for an internal combustion engine according to claim 4, wherein the projection is arranged in accordance with the restriction state of the valve portion.
